(19) United States
(12) Patent Application Publication
(10) Pub. No.: US 2008/0091658 A1
(43) Pub. Date: Apr. 17, 2008

(54) Online Distribution Of Time-Sensitive Content

(76) Inventor: Gary Kremen, San Diego, CA (US)

Correspondence Address: PERKINS COIE LLP, P.O. BOX 2168, MENLO PARK, CA, 94026, US

(21) Appl. No.: 11/865,637

(22) Filed: Oct. 1, 2007

Related U.S. Application Data
(60) Provisional application No. 60/848,321, filed on Sep. 29, 2006.

(51) Int. Cl. G06F 17/30

(52) U.S. Cl. 707/3; 707/E17.014

(57) ABSTRACT

A method is provided for distributing and monetizing online classifieds or eclassifieds. The method includes the steps of gathering and parsing the eclassifieds and then formatting the eclassifieds into a format of information for presentation to a user by a publisher. The method further includes the step of pushing the formatted eclassified to the publisher. The format feeds may be XML feeds, RSS feeds, trusted feeds or email feeds.

### CLAIM OF PRIORITY

This application claims priority to U.S. Patent Application No. 60/848,321 entitled “Online Distribution Of Time-Sensitive Content”, which was filed on Jul. 29, 2007, the contents of which are expressly incorporated by reference herein.

### TECHNICAL FIELD

The present invention relates to advertising, and in particular to the distribution and monetization of online classified advertising.

### BACKGROUND OF THE INVENTION

Search Engines and Online Advertising. There are many processes or mechanisms to search and uncover desired content on the Internet. Search engines are one such mechanism. Generally, search engines operate similarly. In particular, search engines spider or parse the Internet (or from directories such as DMOZ or a combination of both) for information and index and store such information in accordance with proprietary algorithms. Because the Web is dynamic in that information changes frequently, this process continues indefinitely. Search engines typically generate free results or algorithmic results (collectively “Free Search Results”) based on search phrase queries entered by the surfer. In many circumstances, paid results and/or banner or sponsored advertisements precede, follow, surround or intermix with these Free Search Results. The financial model that incorporates these paid results is typically based on CPA (cost per action), CPM (cost per thousand), CPV (cost per view) or PPC (pay per click). In this respect, advertisers, not surfers, pay for the “paid” results. Thus, search engines are considered “free” to a user or web surfer. In practice, surfer clicks or impressions are monetized, and the search engine (or other publisher or those who distribute to the publisher) is paid accordingly.

For purposes described herein, a “publisher” is generally an online entity that displays or publishes paid advertising (in addition to other content). Publishers include, without limitation, search engines, affiliates as described below, directories, portal pages, online forums, online news websites, email newsletters, adware pop-ups, pop-unders and online communities such as Craigslist and other online advertising outlets. Publishers may also include electronic sources (distributed from search engines) such as cell phone displays, electronic displays such as electronic bill boards, cell phone displays, PDAs (personal digital assistants), and handheld devices. Publishers display paid results because they receive a percentage of the advertising revenue collected from the eclassifieds advertiser. Search engines are a unique “subset” of publishers because search engines display results based on user action.

Publishers display paid advertising that may be relevant to non-paid content. For example, when the cnn.com website displays an article on new shoe trends, search engines may display distributed paid advertising that might be paid by shoe stores. The shoe stores pay for such service because they receive a percentage of the advertising revenue.

There also exist others that distribute paid advertising results from the search engine to the publisher. These other distributors are called “advertising distributors” or “third party aggregators.” Also, search engines may use other search engine results from advertising distributors with whom they are not in a partnership relationship, either directly or indirectly.

Online Classifieds. Online classifies are one form of online advertising. Other forms of online advertising include paid advertising or paid results. In the context of paid advertising or paid results, however, online classifieds seldom integrate within this environment. Currently, eclassifieds very rarely, if at all, appear in paid advertising as displayed by publishers. There are several reasons for this, all of which require a bit of background.

Online classifieds or electronic classifieds (“eclassifieds”) are simply classified advertisements available online via the Internet or World Wide Web (“web”), or on any network-connected media or on electronic displays. In short, eclassifieds are electronic representations of classifieds formatted for newspaper, magazine, or other print publication (“traditional classified vendors”). Eclassifieds also include offers for sale listed in online forums and online communities like Craigslist™ as well as items and services offered for auction on internet auction sites. The typical eclassified advertisement represents a unique offer, wherein the underlying content likely changes frequently. The underlying classified content may change for a variety of reasons such as a) a sale of the advertised product, b) a decision not to sell, c) a temporary withdrawal from the market as the advertiser negotiates, changes price or other details of the sale or d) other reasons. Hence, eclassifieds are extremely time-sensitive, fleeting or extremely short-lived and are of little use to anyone unless uncovered by potential web surfers in a very timely fashion.

Rather than directly accessing eclassifieds via their original source (e.g., online versions of print publication, online auction sites, online forums, online classifieds hosting sites, etc.), the typical web surfer might attempt to use one or more search engines to access desired eclassifieds. Search engines are an obvious choice for three reasons. First, the web surfer may be unaware of any or all of the internet (electronic) addresses (URLs) of the relevant publications, auction sites, and classified advertisement sections of online community forums that might display/describe items of interest. Such “items of interest” may include “sell an item(s)” “buy an item(s) or exchange an item(s).” Second, in the case of online newspapers, the market has moved away from online local and regional newspapers and other online sources of classifieds and moved toward national online sources (such as http:/www.cnn.com or http://www.yahoo.com) for news in general. Third, people customize their home pages to view local news directly without brand display (AOL for example offers this service. Local news is displayed without the identification of the name of the local or regional paper). Thus, web surfers are typically less familiar with the online local and regional newspapers. Surfers are more likely to read the non-electronic versions of the local and regional newspapers, if at all.

While search engines (or publisher pages that incorporate searching capability) are a logical choice to search for desired eclassifieds for the reasons described above, such eclassifieds are difficult to uncover because targeted searches rarely match the particular nomenclature of an eclassified due to the archaic nature of the nomenclature. That is, classified nomenclature is typically rigid, cryptic and outdated. Examples of this cryptic outdated taxonomy include terms such as “OBO” (“Or Best Offer.”), “eves” (“evenings”), “4×4” (“Four Wheel Drive”), etc. This nomenclature is a remnant of the past that was largely a product of the cost of paper, limited space on a given paper page, and cost for editing traditional paper based classifieds. The nomenclature is difficult to use in search engine environments as each category has its own nomenclature or structured content. Further, classified nomenclature varies from paper to paper. This nomenclature is different if entered by a surfer, by an advertising representative, etc. (There are attempts at enacting standards. See for example, (http://www.naa.org/technology/cisstdtf/). However, there is no current standard terminology.) This fact makes it even more difficult for a search engine to uncover the eclassified.

In short, search engines usually do not perform better, i.e., uncover desired results with this type of structured content. The search engines lack the lexicon to translate from “human” language to “classifieds language.” Thus, for the reasons described above, web surfers who use publishers' pages such as search engines will likely fail to uncover eclassifieds entirely, uncover the most relevant eclassifieds, or uncover relevant eclassifieds in a timely fashion.

Notwithstanding the overwhelming reason and desire to uncover classifieds in paid search results, the reality is that timely, i.e., current eclassifieds do not appear in paid results because there are to date no adequate mechanisms for achieving such a goal. (Even if such a mechanism existed, indexing of eclassifieds is not viable because there are no static web pages associated with an eclassified. Search engines have problems indexing such pages.) There is also another very practical reason eclassifieds do not currently appear in search requests. Search engines are not intended (designed) to uncover eclassifieds because search engine companies and traditional eclassified providers are direct competitors.

Over the years, new media (search engine) companies have increased their advertising market share (largely at the expense of traditional advertising providers). Therefore, providers and/or distributors of eclassifieds often view search engine providers (and publishers of their results) as competitors, and vice versa. This is particularly true in the areas of branding and customer retention. Newspapers and other traditional classifieds providers (old line media companies) perceive Google, Yahoo and other search engine companies as competition. This competition detracts from meaningful cooperation between eclassified distributors and search engines (publishers of search engine results). This in turn makes it more difficult for the web surfer to uncover meaningful content. In short, there is no financial incentive for companies in both markets to establish business relationships. The lack of cooperation between eclassified providers, search engines and advertising distributors is the primary cause of the failure of search engines to display desired eclassifieds in a meaningful way and timely manner to web surfers. The same is true for those who publish search engine results.

Finally and equally important, timely search engines would not uncover timely eclassifieds even if indexing were viable. The duration between indexing operations by search engines (and their associated distribution network to show such search results to affiliate publishers) is substantial due to the overwhelming amount of content on the Internet. In other words, there is an extensive delay between the introduction of new or modified content to the web and the indexing of such content by a search engine. This delay (time-consuming process) may extend from days to months. Google® for instance currently has about a six-week delay or latency period, by which point digital content such as eclassifieds is often irrelevant. In common case, an eclassified may no longer exist on a publisher's or newspaper's online sites. For example, the pointer format (to the eclassifieds) or the link pointing to the digital content may no longer function. In some cases, the results of the indexing (which might be more than three months old) are cached. However, such cached content is usually useless because of its age in relationship to the extreme time sensitive nature of classifieds.

There are other difficulties that create a barrier between eclassified content providers and their intended audience. Search engines such as Google® and AllTheWeb use numerous different techniques to locate and prioritize results. As a result, there is no single eclassified content taxonomy that is ideal for exposure to all search engines (in addition to the non-indexable nature of certain eclassifieds). Thus, inconsistency among search engine algorithms creates an even greater wall between eclassified content providers and their intended audience.

Because eclassifieds are more difficult to integrate with search engines for all of the reasons described above, eclassifieds achieve less than their full potential value. Therefore, the value of eclassifieds is diminished.

Based on the foregoing, there is a need for an online distribution method for time-sensitive content.

### BRIEF DESCRIPTION OF THE INVENTION

The present invention relates to the distribution and monetization of online classified advertising. Such online classified advertising may appear in online newspapers, auction offers on auction sites (such as EBay) and classifieds on network-connected media such as Craigslist™ (collectively “eclassifieds”). In short, classified advertising changes constantly. That is, the classified content is time-sensitive from the perspectives of the person placing the advertisement and the person viewing the advertisement. The invention incorporates techniques or methods that offer timely eclassified advertising to a wider online audience than ever offered to before. The invention incorporates techniques that distribute eclassifieds and other time-sensitive content to online publishers. “Publishers” include (and used hereinafter to mean) search engines (also referred to hereinafter as “affiliates”), affiliates, directories, portal pages, online news websites, adware pop-ups, pop-unders, online forums and online communities (such as Craigslist), and other online advertising outlets as well as electronic sources (distributed from search engines) such as cell phone displays, electronic displays such as electronic bill boards, cell phone displays, PDAs (personal digital assistants), and handheld devices.

The described distribution techniques use real-time XML feeds, RSS, emails, real-time data dumps, non-real time data dumps, information caches, trusted feeds, paid inclusion, or email feeds or other related protocols (collectively “Distribution Methods”). The actual Distribution Methods that distribute eclassified from the eclassifieds provider to the publisher are based on the type of publisher and the type of eclassified information as well as on the user or web-surfer (“surfer”), the location of the demographic, the psychographic profile of the surfer, the previous searches by the surfer, the previous surfer behavior, bandwidth requirements of the surfer, etc. Additionally, the eclassifieds' provider might use multiple or indirect Distribution Methods to feed the publisher.

The present invention incorporates methods for eclassified distribution and for translating (including converting) the taxonomy or nomenclature of eclassifieds into a suitable taxonomy for pushing the eclassifieds into a format usable by the publishers.

According to one aspect of certain embodiments of the present invention, time-sensitive eclassifieds can be pulled from various online sources of eclassifieds such as up-to-date online newspapers, online auction sites, online communities such as Craigslist™, etc. The pulled data is parsed and formatted (i.e., converted or reformatted) into suitable display listings and directly fed to publishers such as search engines. According to one aspect of some embodiments of the invention, the mechanism for feeding publishers such as search engines can be in the form of XML (eXtensible Markup Language) feeds, or RSS (Really Simple Syndication) feeds, paid-inclusion feeds, email feeds, etc. Eclassified reformatting may include 1) stripping contact information from the display listing to encourage the web surfer to click through or 2) providing anonymous contact information such as NYM (pseudonym).

According to another aspect of the present invention, one or more of the online sources of eclassifieds can optionally push their eclassifieds to a pre-determined repository in some standard or agreed-upon format. The eclassifieds stored in the repository are parsed and reformatted into suitable display listings for direct feeding to publishers such as search engines and online communities.

According to yet another aspect of certain embodiments of the present invention, branding services can be provided to the online sources of eclassifieds. For example, in addition to creating the display listings for display to a web surfer, a landing web page can be created with the look & feel of the particular online source. When the web surfer clicks on the URL in the display listing, the web surfer is taken to the landing page for that particular online source. Alternatively, the web surfer is taken to the actual web site of that particular online source. According to another aspect of certain embodiments, the search results are selected based on the geographic location of the web surfer.

In another embodiment of the present invention, a computer-implemented method is described for providing at least one eclassified in response to a user's online search request, the method comprising: aggregating eclassifieds from a plurality of online sources in accordance with the user's search request.

In yet another embodiment of the present invention, a computer-implemented method is described herein for providing an eclassified in response to a user's online search request, the method comprising: translating the eclassified into a format for presentation to a user by a publisher.

In yet another embodiment of the present invention, a computer-implemented method is described herein for distributing time-sensitive digital information, the computer-implemented method comprising: accessing the time-sensitive digital information from a plurality of online sources of time-sensitive information; parsing the time-sensitive digital information; reformatting the parsed information into a suitable format for distribution; and sending the formatted time-sensitive digital information as a display listing to a user in response to a request for the time-sensitive digital information.

In yet another embodiment of the present invention, an aggregator is provided for aggregating at least one eclassified in response to a user's online search request, the aggregator comprising: a format engine for formatting the eclassified into a format of information suitable for presentation to a user by a publisher; and

a push engine for pushing the formatted information to the publisher for presentation to the user.

In yet another embodiment of the present invention, an instantiated computer process is provided comprising executable for aggregating eclassifieds from a plurality of online sources in response to a request.

In another embodiment of the present invention, a computer-implemented method for monetizing a request for search results from a user, the method comprising: providing a user with an online search interface, said online search interface enabling said user to make search requests; receiving a specific search request via said online search interface, said specific search request received from said user; and retrieving eclassifieds from a plurality of online sources, and aggregating said eclassifieds.

In yet another embodiment of the present invention, a computer-implemented method is provided comprising: aggregating eclassifieds from a plurality of online sources that relate to a portion of online content.

### BRIEF DESCRIPTION OF THE DRAWINGS

FIG. 1A illustrates some high-level aspects of certain embodiments of the present invention.

FIG. 1B illustrates a network diagram for the communication of digital text (and/or graphical information such as banners) by a user to an aggregator (for conversion) according to embodiments of the invention.

FIG. 2 is a flow chart illustrating an aggregator method in accordance with one embodiment of the invention.

FIG. 3 is a flow chart of a method for converting digital content such as an eclassified file into a push format in accordance with another aspect of the invention.

FIG. 4 is a data structure for use with one push format of the invention.

FIG. 5 is a flow chart illustrating a method for retrieving pertinent data from an eclassified data record of a non-push format.

FIG. 6 is a flow chart illustrating a method for preparing pertinent data into push format together with supporting data structures.

FIG. 7 is an example eclassified having a format derived directly from a print classified.

FIG. 8 illustrates a reformatted version of the eclassified of FIG. 7 in accordance with one embodiment of the invention.

### DETAILED DESCRIPTION

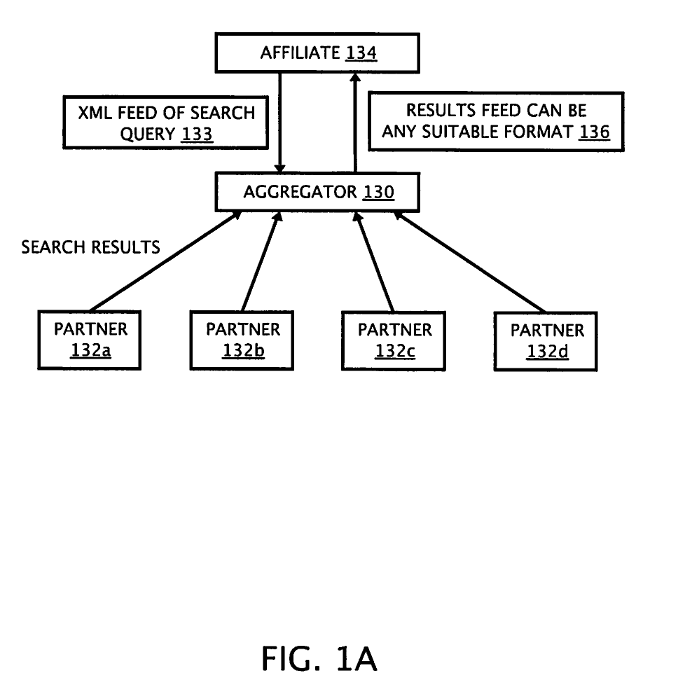

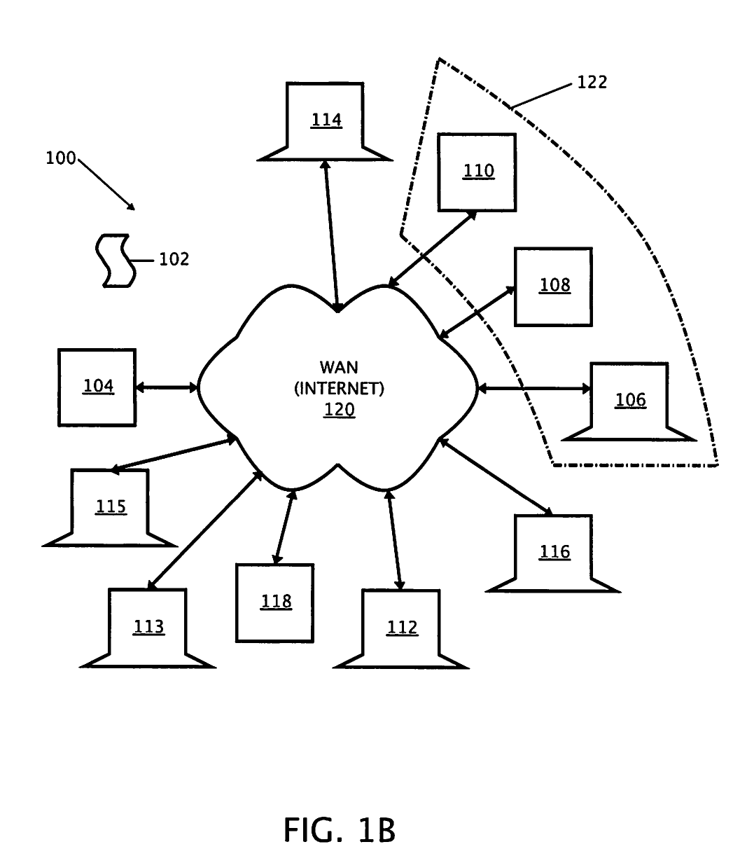

FIG. 1A illustrates some high-level aspects of certain embodiments of the present invention. In FIG. 1A, an aggregator 130 (i.e., third party aggregator) forms partnerships with a number of affiliates 134 (only one of which is shown in FIG. 1A) and a plurality of partners 132a-d or sources of time-sensitive content (or information) such as eclassifieds for purposes of monetizing the time-sensitive content. Partners are sources of paid advertisements. The aggregator 130 is also referred to herein as an exchange. An exchange is an entity that is an intermediary between affiliates and other partners of the exchange such as aggregator 130. (The term “partnership” refers to a business relationship and is not restricted to any particular type of business relationship, and thus may vary from implementation to implementation.) The affiliates 134 as described and referred to herein are search engines. An affiliate is a site where the web surfer types in his search query. Non-limiting examples of sites where the web surfer might type in his search query include adware pop-ups and cell phone Java clients. (An affiliate could also be adware pop ups, cell phone java clients, etc.). The plurality of partners or sources 132a-d may also be search engines.

While many affiliates including search engines have their own advertising listings, search engines are in the business of providing their paid listings to other search engines. In such a context, search engines are partner sites. Thus, a search engine may either act as (be an) affiliate or a partner site, depending on where the web surfer enters a search engine query.

To illustrate by way of example, according to certain embodiments, assume that a web surfer types in a search phrase on an affiliate site. The affiliate site converts the search phrase into a real-time XML query feed 133. The embodiments, however, are not restricted to XML or real-time feeds. First, the affiliate may query the affiliate's own internal advertising base or the affiliate's own partners' sites in an attempt to satisfy the web surfer's search query. The affiliate site then pushes the search query XML feed 133 to the aggregator 130. The aggregator 130 attempts to find paid advertising in the aggregator's 130 databases that satisfies the search query. If none of the aggregator's 130 databases contain any content that satisfies the search query, then the aggregator 130 will pull content that satisfies the search query from one or more sources 132a-b (i.e., partner sites). The content that satisfies the search query is herein referred to as search results.

According to certain embodiments, the search results can be sorted by prices or other relevant criteria. When the aggregator 130 obtains the search results, either from querying its own databases or by pulling search results from one or more sources 132a-b, the aggregator 130 converts the search results into an XML search results feed 136. According to one aspect of certain embodiments, the search results are selected based on the geographic location of the web surfer. The geographic location of the web surfer can be determined from the web surfer's IP address. For example, only the search results that satisfy the constraint “within 50 miles of the web surfer's geographic location” are selected.

The aggregator 130 then pushes the XML search results feed 136 to affiliate 134 to satisfy the web surfers search query. Other forms of push format can be used. Non-limiting examples of types of feeds are RSS feeds, email feeds, trusted feeds, etc.

In short, the aggregator 130 acts as a translator that translates the eclassified (also referred to as eclassified content or information) into a format for presentation by a publisher such as a search engine. That is, the translator (aggregator 130) gathers the eclassified information or content, parses (i.e., analyzes or breaks down) the eclassified information and then converts (formats) it into a format for presentation (or performs the parsing and converting in reverse). This is described in more detail below.

It is to be noted that the elapsed time starting when the web surfer enters the search query up to the time when the web surfer sees the results displayed on the affiliate site is a fraction of a second. The complex manner in which the web surfer's search query is satisfied is performed seamlessly and is completely transparent to the surfer. Thus, the surfer is provided with a positive surfing experience.

The query feed in push format may take a variety of forms (e.g., XML query) and may vary from implementation to implementation. According to certain embodiments, the push format may include a title element, a keyword search element, a description element, a support URL element, an IP address, and a monetization URL element. The query feed may also include information such as the geo-location of the web-surfer, the demographic and psychographic profile of the web surfer and bandwidth requirements of the web-surfer. Such information can be used to tailor the search results for the web surfer. An example of an XML query is:

http://xml.kanoodle.com/xml.php?Terms=“surfing in San Diego” &strict=1&Hits_Per_Page=10&IP=209.81.7.23&affiliate=www.galaxysearch.com

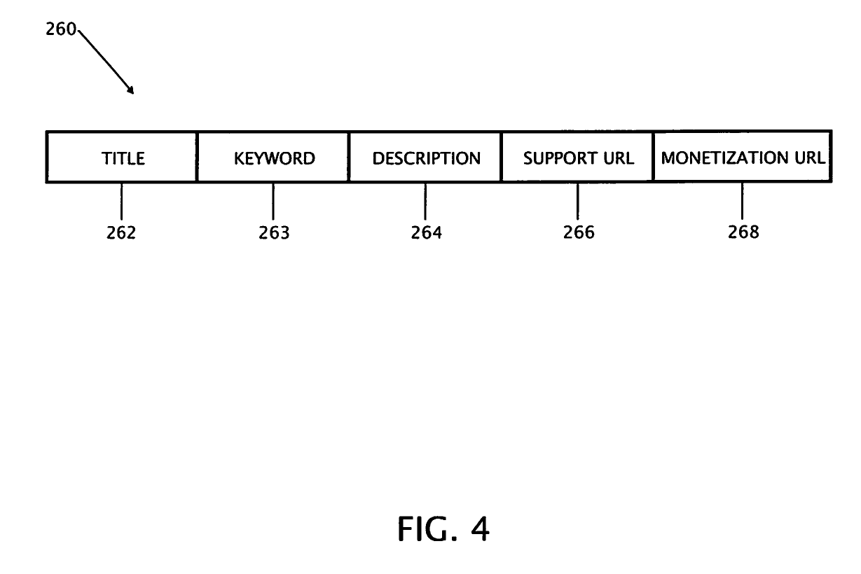

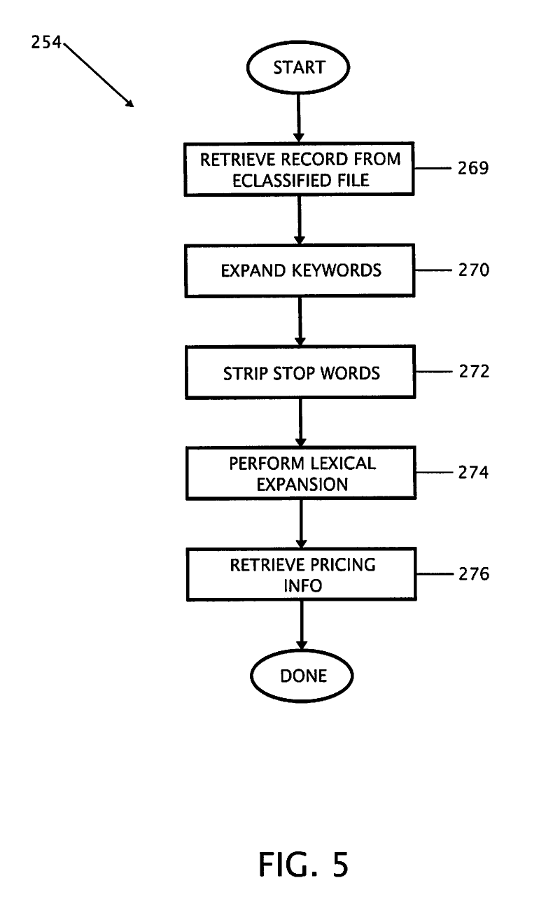

The XML push format is described in greater detail herein with reference to FIG. 4 and FIG. 5. According to certain embodiments, data dumps or FTP (File Transfer Protocol) may used instead of XML.

When the affiliate site receives the search results feed, the affiliate sorts the listings in the search results for display. The listings in the search results that generate the most profit for the affiliate are displayed most prominently. To illustrate, assume for example, if a surfer types in “Surfing in San Diego” at http://www.Kanoodle.Com, Kanoodle might only have three listings starting at $0.06 and going to $0.04. In this case, Kanoodle will likely query its partners with this search term. Assume for example that GalaxySearch is one of these partners. Further assume that GalaxySearch only has two of its own paid listings for “Surfing in San Diego,” one at $0.20 and another at $0.06. If Kanoodle and GalaxySearch have a 60% revenue sharing arrangement, Kanoodle will list the GalaxySearch listing at $0.12 (60%*$0.20) return first. Then Kanoodle will then display its own listings at $0.06, $0.05 and $0.04 in the second, third and fourth positions. Last, Kanoodle will display a GalaxySearch listing at $0.036 (60%*$0.06), following the other listings.

As part of GalaxySearch's list finding process, GalaxySearch might also query its own set of proprietary partners (other than Kanoodle to prevent loops) looking for “Surfing in San Diego.” If paid listings are found and a “time out” has not occurred, the listings from GalaxySearch's partners will be sent to GalaxySearch in accordance with the revenue sharing arrangement between GalaxySearch and its partners. Then those results from GalaxySearch's partner and its own results are sent to Kanoodle. At this point, Kanoodle sorts all the results by the net revenue that Kanoodle would receive and displays the results accordingly.

Further, the aggregator 130 is adapted to perform fraud checks on the search results before the results are pushed to the affiliates. Fraud checks include checking the results for accuracy and legality. For example, no child pornography material will be allowed to pass through the feed. As another example, checks are made to ensure that a click is carried out by a human searcher rather than a robot.

Thus, the aggregator 130 can satisfy, for both affiliates and web surfers, the priorities that include: 1) relevancy of results, b) speed of results, and c) results displayed correctly on their browser.

To reiterate, the partnerships described allow the aggregator 130 to:

1) gather the time-sensitive content by XML feed 136 from aggregator 130 (that aggregates or translates the eclassified information from the partners 132a-d;

2) process the time-sensitive content to form customized formatted content (The process involves eclassified content parsing and converting as described below.); and

3) feed or push the customized formatted content directly to the plurality of affiliates 134 (search engine providers) in the partnership.

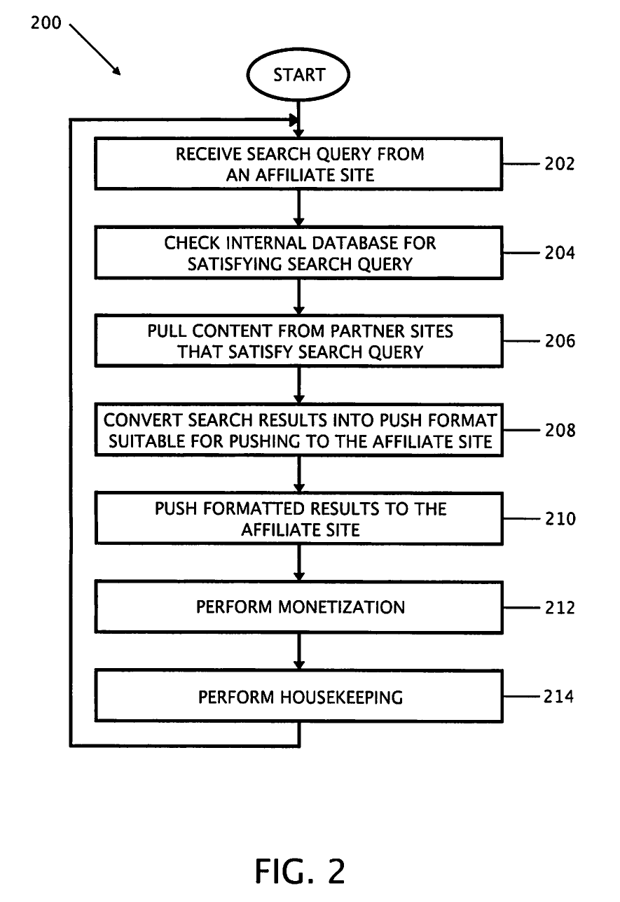

The processing of the time-sensitive content to form customized formatted content is described in greater detain herein with reference to FIGS. 2-8. New time-sensitive content and any updates are pulled in real-time from the plurality of partner sites to the aggregator 130 site for processing into customized formatted content. The customized formatted content is stored in a database, according to certain embodiments.

The aggregator 130 attracts affiliates (search engine providers) 134 into the partnership by performing one or more of the following:

1) providing time-sensitive content to the affiliates (search engine providers) that the search engine providers would otherwise not obtain without a great deal of effort;

2) providing a fruitful experience to web surfers who use the search engines of the search engine providers in the partnership by giving the web surfers rapid and relevant search results in response to queries for time-sensitive content. Thus, the traffic is increased at the search engine providers' sites;

3) providing clean listings by checking for accuracy and legality;

4) increasing the value and prices that the affiliates can charge for advertising space because of increased traffic at their sites;

5) associating with a highly profitable anchor e-business that earns a substantially large market revenue in order to increase traffic for the affiliates;

6) sharing revenue obtained from monetizing the time-sensitive content with the affiliates;

7) providing transparency in accounting; and

8) providing fraud accounting protection.

The aggregator 130 attracts providers of time-sensitive content (partner sites) into the partnership by performing one or more of the following:

1) providing a one-stop service for feeding the partner's time-sensitive content to some or all of the affiliates;

2) providing an upsell to the originator (e.g., advertiser of the e-classified) of the time-sensitive content when the originator submits his/her e-classified to partner sites;

3) providing branding for the partner sites by a) linking the web-surfer directly to the partner's landing (original) site, b) including the partner's logo as part of the search results listing or at premium advertising spaces at affiliate sites;

4) providing a conduit for pushing the time-sensitive content to international affiliates;

5) increasing high quality traffic for the partner sites;

6) increasing the prices that the partners can charge for advertising space because of the increased high quality traffic;

7) providing transparency in accounting; and

8) providing fraud accounting protection.

Payment to the aggregator 130 may come from the originator of the time-sensitive content or the partners 132a-d. The aggregator 130 may then share the revenue with the affiliate 134 or the affiliates. The search engine providers may share in the revenue based on at least one payment method selected from a group comprising: 1) cost per thousand impressions (CPM), 2) pay-per-click (PPC), and 3) fixed fee.

Further, certain embodiments teach a variety of mechanisms for generating and reformatting time-sensitive digital content for maximum exposure on the connected networked media such as the Internet. Such mechanisms include those by which digital content is properly formatted and pushed out and thus displayed substantially immediately by search engines as paid results (PPC, for example). Other aspects include mechanisms for ensuring that digital content is featured prominently on the web sites of search engine providers. For example, in certain embodiments, there are mechanisms by which an eclassified search uncovers eclassifieds in relevant text listings, banners, pop up windows, pop up under exit consoles, etc.

The original content underlying an eclassified may be submitted by a user via legacy newspaper storage systems. Alternatively, the eclassified may be changed or converted to an eclassified or to an electronic form via a web interface. The text submitted may subsequently be reformatted by applications, local processes, or other software. Such software may be configured to parse and reformat the content into a form suitable for direct feeding to search engine sites in response to a search query. In short, aggregator 130 (or translator) gathers, parses and formats (i.e., reformats or converts) the eclassified information and sends or pushes it for distribution to and presentation by a publisher. In short, this translation or aggregation essentially converts the eclassified content from a lexicon (glossary) associated with classifieds into search phrases understood by consumers using search engines. The resulting formatted information is then sent or pushed to the search engine in the proper format for presentation by a publisher (in paid results area).

As will be appreciated, embodiments of the invention can be responsive to digital content in any available format. Typical formats used for digital content in this context include plain text such as ASCII, encoded markup languages such as HTML, and specialized encoding languages such as those used by eclassified providers and newspaper production systems. In some embodiments, the content may be customized for particular search engines so that the content is featured prominently by such search engines when certain search terms are presented to the search engine. These and other embodiments are described in greater detail infra.

The present invention includes embodiments particularly suited for timely digital content which decreases in relevance over time. Given the time-sensitivity of the content, immediate access to such materials by web surfers is imperative to the content holder, and the invention supports automated techniques for reformatting and distributing such content to address these requirements.

An example of such time-sensitive content is presented by eclassified advertisements. Typically, Internet-based eclassifieds are posted to sites supporting such ads, and these types of advertisements are rarely indexed by search engines, if at all, in a timely fashion. Moreover, such advertisements are often lost in a myriad of search results offered by typical search sites. As will be appreciated by those skilled in the art, eclassifieds are but one example of such time-sensitive content. Many other examples shall be readily apparent to one skilled in the relevant arts.

FIG. 1B schematically illustrates a network architecture 100 that may be used by embodiments of the present invention. The network architecture 100 includes time-sensitive digital content 102, a web surfer computer 104, a format engine 106, a push engine 108, a monetization engine 110, search engines 112, 113, 114 and 115, an eclassified-source website 116, and an online newspaper website 118, all coupled bi-directionally through a wide area network (WAN) such as the Internet 120.

An advertiser through a variety of mechanisms may submit the time-sensitive digital content 102, such as an eclassified. Other sources of time-sensitive digital content 102 include advertising distributors and publishers. The input mechanisms include a form presented via a web interface, legacy eclassified advertisement production systems, and/or third party eclassified brokers. These input mechanisms are made available to the advertiser through the advertiser computer 104. The data is then stored as digital content in any suitable format and made available over the web through a source such as the eclassified-source website 116 or the online newspaper website 118. Typical formats for storing digital content in this context include plain text format as entered by the advertiser such as ASCII, encoded markup languages such as HTML and specialized encoding languages such as those used by eclassified providers and newspaper production systems.

The format engine 106 is operable, i.e., designed to convert the digital content, as input by the advertiser or as formatted by the eclassified provider/distributor, into a specified “push” format well suited for direct feeding, by XML feed for example, to search engines 112, 113, 114 and 115, in response to a search query by a web surfer.

The push engine 108 operates on the push formatted digital content so that such content can be directly fed or “pushed” to a search engine (112, 113, 114, 115) in response to search queries submitted on the search engine site. For example, the push engine 108 may be further operable to present the digital content to the search engines such that the digital content is featured prominently when certain search terms are presented to the search engine 112.

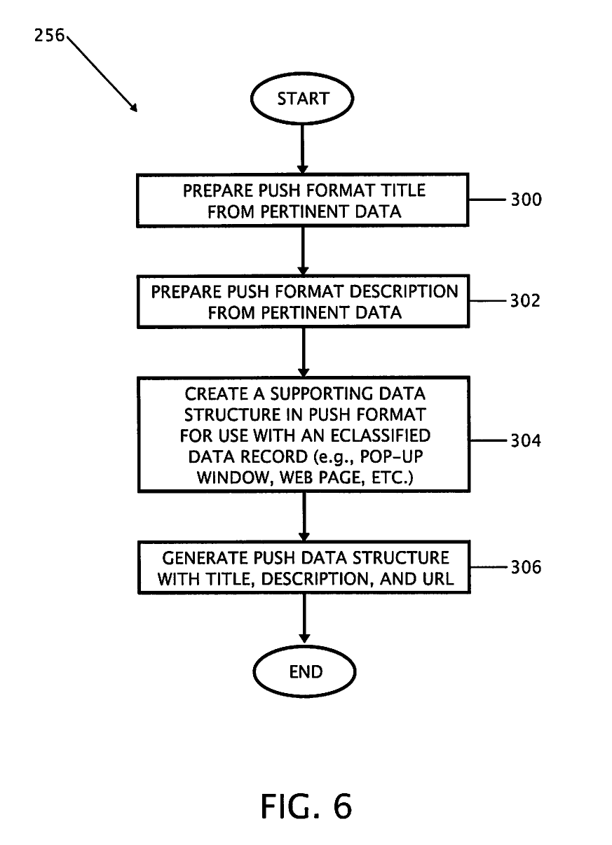

The monetization engine 110 attends to any necessary accounting associated with the format and push processes. As will be appreciated, the service of formatting and pushing digital content into search engine indexes for prominent display can readily be monetized by any aggregator 130 providing these services. Payment for these services may come directly from the advertiser. More likely, eclassified distributors (partner sites) will pay the third party for the distribution of large blocks of eclassifieds, the cost of this being passed onto the advertiser indirectly either hidden in the basic advertising cost or as an extra feature. Aspects of aggregators will be described below in more detail with reference to FIG. 6.

According to certain embodiments, the aggregator 130 acts as an independent service provider implementing certain aspects of some embodiments on a global scale. A portion of one method for implementing the aggregator 130 is described in more detail below with reference to FIG. 6. The aggregator 130 would receive the eclassified data in any format used by the eclassified provider, attend to reformatting into a push format, pushing the digital content into the search engines and monetizing the transaction. With reference to FIG. 1B, aggregator 130 includes the functionality of the format engine 106, the push engine 108, and the monetization engine 110. In some embodiments, these three engines will be found on a single aggregator server 122 indicated by the hashed lines. Alternatively, these services could be distributed across the Internet 120.

FIG. 2 illustrates a flow chart of a method 200 for an aggregator to perform a push and format operation on digital content in accordance with one embodiment of the present invention. The aggregator such as aggregator 130 may be implemented as an application instantiated on a server computer coupled to the Internet. Alternatively, portions of the aggregator 130 may be distributed across various servers coupled directly or indirectly to the Internet. One possible set of processes for implementing an aggregator 130 is described above with reference to FIG. 1B.

The method 200 begins at step 202 where the aggregator 130 receives a search query from an affiliate site 134. According to one embodiment, the search query is in the form of an XML feed. At step 204, the aggregator 130 checks the aggregator's 130 internal database for search results that will satisfy the search query. If the aggregator 130 does not uncover desired search results, at step 206, the aggregator 130 then attempts to pull such content from partner sites 132a-d.

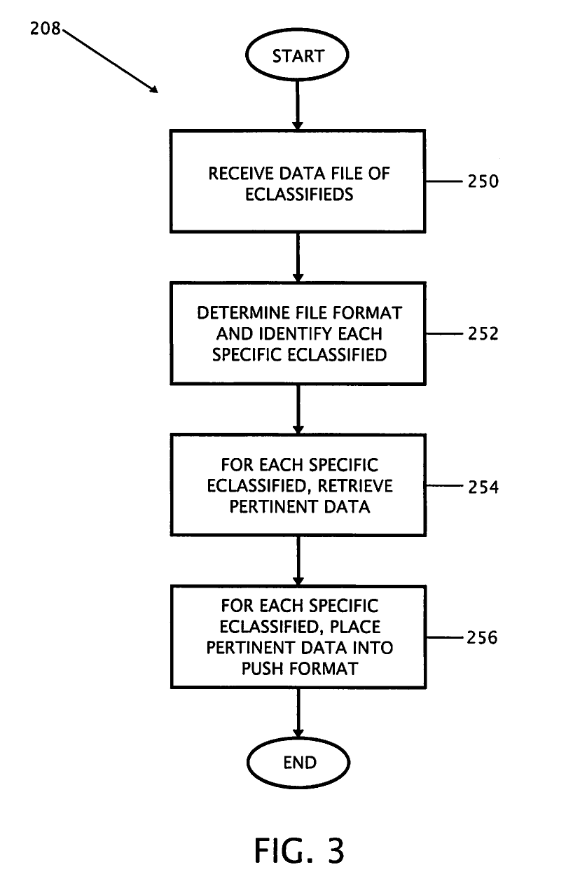

At step 208, the aggregator 130 converts the digital content into the requested push format. The push format may take on a variety of forms. For example, certain embodiments contemplate generating title, description, URL elements, anonymous contact information, etc. The push format may include other elements such as an IP address information element and a key word search element. The data found at the linking URL might provide a landing web page for branding purposes, a pop-up window, or perhaps the URL directs to the original source of the eclassified or some data. One method for generating push formatted eclassifieds is described below in more detail with reference to FIG. 3, and one data structure for use in push formatting is described below with reference to FIG. 4.

At step 210, the aggregator 130 pushes the formatted search results to the affiliate site that sent the search query to the aggregator 130. At this point the substantive portion of the transaction has been completed. At step 212, the aggregator 130 monetizes the successfully completed transaction. Monetization may take on a variety of forms. For example, the aggregator 130 may perform account management for revenue sharing in the event the web surfer clicks through to the eclassified (in a PPC model). Alternatively, the aggregator 130 may update a database for periodic billing, or update a database for later accounting.

After the monetization step 212, the aggregator 130 performs any necessary housekeeping functions at step 214. For example, in some embodiments usage statistics are maintained in an aggregator database. Additionally, a receipt and other transaction information may be transmitted to affiliates and partners.

Turning next to FIG. 3, an eclassified conversion (format) method 208 in accordance with one embodiment of the invention will now be described. The conversion method 208 is one suitable embodiment for implementing the step 208 of FIG. 2 when the digital content intended for push formatting is an eclassified file.

At step 250, a data file of eclassifieds is pulled (and received) in a format specified by the aggregator 130. Step 252 determines the format of the eclassified data file in order to properly parse and format the file. A step 254 retrieves pertinent data from each eclassified present in the eclassified file. This data will include information such as pricing, product or service, source of origin of the eclassified, contact data, etc. One suitable method for implementing step 254 is described below in more detail with reference to FIG. 5.

Continuing with FIG. 3, a next step 256 places the retrieved pertinent data into the specified push format together with any supporting data structures, for each retrieved classified. One suitable push format is a data structure 260 as shown in FIG. 4 and described immediately below. One suitable method for implementing step 256 is described below in more detail with reference to FIG. 6. After step 256, the method step 208 is complete.

FIG. 4 illustrates one suitable push format data structure 260. The push format data structure 260 includes a title element 262, a keyword element 263, a description element 264, a support URL element 266, and a monetization URL element 268. The title element 262 is for storing an eclassified title that would be meaningful to the web surfer. The keyword element 263 is for storing keywords stripped and/or generated from the eclassified. The description element 264 is for storing a narrative of the eclassified aimed at the web surfer. The support URL element 266 is for storing an indirection to a supporting data structure such as a pop up window or web page providing additional information regarding the eclassified, or may indirect directly to the eclassified web site provider. The monetization URL element 268 is for storing an indirection used for billing of an end search engine and potential intermediate search engines. As will be appreciated, data structures according to other embodiments may be arranged differently and have additional or fewer elements. Such indirection is known to those skilled in the art.

FIG. 5 illustrates a flow chart of a method for step 254 for retrieving pertinent data from an eclassified file not yet placed into a push format. A step 269 retrieves a data record for a single eclassified add found in the eclassified file. A step 270 expands all keywords found in the data record. For example, many phrases in the eclassified context are typically represented through established acronyms (*lexicals or taxonomy*) such as OBO for “or best offer.” Expansion of these words renders the text more meaningful for later formatting. A next step 272 removes unnecessary stop words (“a,” “the,” “if” etc.).

Following step 272, a step 274 performs lexical expansion in a manner that will provide a more meaningful search later. For example, the term “car” may be expanded into the set “car, cars, auto, autos, automobile, automobiles” etc. A final step 276 retrieves pricing information. As will be appreciated, other information may be relevant depending upon the format and requirements of specific search engines. The data retrieval steps of FIG. 5 simply provide one example from which the skilled artisan may readily extrapolate.

FIG. 6 is a flow chart illustrating a method for method step 256 for formatting the retrieved data into a push format in accordance with certain embodiments. A step 300 prepares a text title (push format) from the retrieved eclassified data. A step 302 prepares a text description (push format) from the retrieved eclassified data. A step 304 creates a supporting data structure (push format) for use with an eclassified data record made from the formatted and retrieved data. Possible data structures include a related pop up window and a web page. A step 306 then generates a data record 260 as illustrated in FIG. 4, with a title 260, description 264 and URL 266 pointing to the supporting data structure.

In summary, the aggregator 130 as described above operates as a translator that translates the eclassified (content or information) into a format for presentation by a publisher such as a search engine. As a translator, the aggregator 130 gathers, parses and formats (converts or reformats) the eclassified information. Specifically, the eclassified content is identified and analyzed. As part of this process, words (from the eclassified or its category of placement) may be expanded, added or removed accordingly to ensure that a search uncovers desired eclassifieds. For example, certain critical words or characters of the eclassified or its category (of placement for classified) may be identified during this part of the translation process. The aggregator 130 then formats (converts) the analyzed content into a format suitable for a publisher to (interpret and) and present to a user. The aggregator 130 then pushes the formatted information to the publisher for display (in the paid results or sponsored section). As one skilled in the art will understand, the order of these steps (the process) may be varied to achieve the same results.

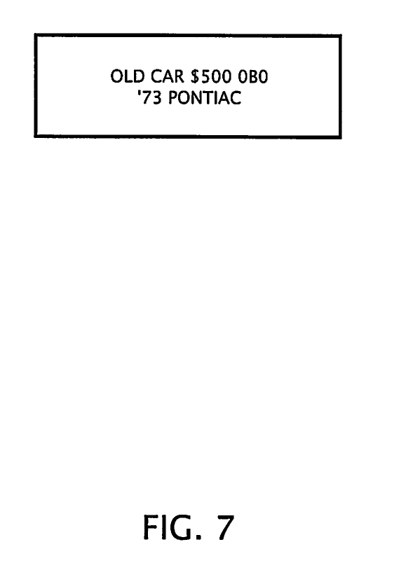

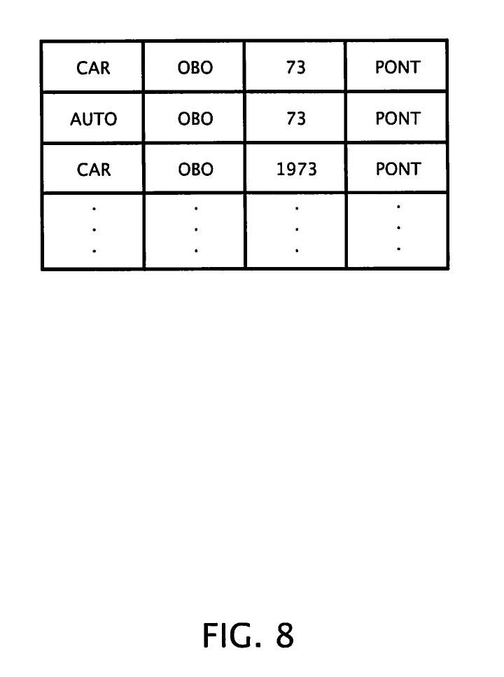

With reference to FIGS. 7-8, one particular example of the operation of the aggregator 130 will now be described. FIG. 7 illustrates data found in an eclassified derived from a classified for a 1973 Pontiac originally found in a newspaper. Following the techniques described above, the keywords and data in the eclassified shown in FIG. 7 are expanded into a data structure such as shown in FIG. 8. FIG. 8 provides a wide variety of expressions for the underlying eclassified content of FIG. 7. As will be appreciated, this format allows for increasing the likelihood of this eclassified being present or uncovered in a relevant related search.

In embodiments of the present invention, the format (conversion) engine 106 may be resident on servers remote from the user entering the text of the eclassified advertisement. In some embodiments, the format (conversion) engine 106 is in communication with the user via a web browser linked to the servers operating the format (conversion) engine via HTTP or an equivalent networking protocol. As a non-limiting example, the engine may be triggered by a Common Gateway Interface (CGI) daemon engaged after receipt of user commands at a server remotely linked to the user. In alternative embodiments, the format (conversion) engine 106 may be a process at least partially resident on a terminal 104 employed by the user for entry of the text of the eclassified ad. By way of non-limiting example, the format (conversion) engine may be at least partially contained as an executable file on a web browser such as a plug-in. Alternatively, the format (conversion) engine 106 may operate locally to the user, in the form of a scripting language such as JavaScript® of Sun Microsystems of Palo Alto, Calif.

Upon formatting (conversion), the advertisement is encoded in a markup language in a specialized format by the push engine 108. The markup language may include HTML, XML, SGML, or other markup language. The format (conversion) engine 106 may include separate customizations targeted to distinct search engines.

Note that the algorithms and techniques described above are for illustrative purposes only, and many alternatives shall be apparent to those skilled in the art. In particular, those skilled in the art shall recognize that eclassifieds are but one example of time-sensitive content whose exposure can be maximized by the techniques described herein. The present invention is equally applicable to any other sort of time sensitive content, illustrative, non-limiting examples of which include public notices, news articles, and myriad other examples that shall be apparent to those skilled in the art.

I claim:

1. A computer-implemented method for providing at least one eclassified in response to a user's online search request, the method comprising:
aggregating eclassifieds from a plurality of online sources in response to the user's search request.

2. The method of claim 1 wherein the step of aggregating includes the step of converting the eclassifieds into a format of information suitable for feeding to a publisher.

3. The method of claim 2 wherein the format is an XML feed.

4. The method of claim 2 wherein the step of aggregating further includes the step of pushing the formatted eclassified into search engines.

5. A computer-implemented method for providing an eclassified in response to a user's online search request, the method comprising:
translating an eclassified into a format for presentation to a user by a publisher.

6. The computer-implemented method of claim 5 wherein the step of translating includes the step of removing an unnecessary portion of the eclassified to enable the eclassified to be uncovered by a search engine.

7. The computer-implemented method of claim 5 wherein the step of translating includes the step of adding at least a portion of information to the eclassified to enable the eclassified to be uncovered by a search engine.

8. The computer-implemented method of claim 5 wherein the step of translating includes the step of selecting a portion of the eclassified to enable the selected portion of the eclassified to be uncovered by a search engine.

9. The computer-implemented method of claim 8 wherein the portion selected is one or more characters of a word within the eclassified or the category for such eclassified.

10. The computer-implemented method of claim 5 wherein the step of translating includes the step of converting the eclassified into a format for presentation to the user by the publisher.

11. The computer-implemented method of claim 5 further comprising the step of pushing the formatted eclassified into a publisher.

12. The computer-implemented method of claim 11 further comprising the step of monetizing the step of translating.

13. A computer-implemented method for distributing time-sensitive digital information, the computer-implemented method comprising:
accessing the time-sensitive digital information from a plurality of online sources of time-sensitive information;
parsing the time-sensitive digital information;
formatting the parsed information into a suitable format for distribution; and
sending the formatted time-sensitive digital information as a display listing to a user in response to a request for the time-sensitive digital information.

14. The computer-implemented method of claim 13 further comprising updating the time-sensitive information before sending the time-sensitive information to the user.

15. The computer-implemented method of claim 13 wherein accessing the time-sensitive information includes using trusted feeds or paid-inclusion feeds.

16. The computer-implemented method of claim 13 wherein accessing the time-sensitive information includes using XML feeds.

17. The computer-implemented method of claim 13, wherein accessing the time-sensitive information includes using RSS feeds.

16. The computer-implemented method of claim 13 wherein accessing the time-sensitive information includes using email feeds.

19. The computer-implemented method of claim 13 wherein sending the time-sensitive information includes sending the time-sensitive information to a search engine where the user made the request for the time-sensitive information when performing a search query.

20. The computer-implemented method of claim 13 wherein sending the time-sensitive information includes sending the time-sensitive information to an online forum where the user made the request for the time-sensitive information.

21. The computer-implemented method of claim 13 wherein sending the time-sensitive information includes sending the time-sensitive information to the user through email.

22. The computer-implemented method of claim 13 wherein the plurality of online sources includes a classified advertisement section of online newspapers.

23. The computer-implemented method of claim 13 wherein the plurality of online sources includes sites that host offers for sale.

24. The computer-implemented method of claim 13 wherein the plurality of online sources includes online auction sites.

25. The computer-implemented method of claim 13 wherein the online auctions can be of any type including a local auction, a regional auction, a national auction, and an international auction.

26. The computer-implemented method of claim 13 wherein the plurality of online sources include online forums.

27. The computer-implemented method of claim 13 further including repackaging the parsed information into suitable format for distribution, the repackaging step including providing branding for the time-sensitive information based on a source of the time-sensitive information.

28. The computer-implemented method of claim 27 wherein providing branding includes creating a landing page using pre-determined look & feel associated with the source, and wherein a URL associated with the landing page is provided in the display listing the customer.

29. The computer-implemented method of claim 27 wherein providing branding is performed statically using pre-determined look & feel associated with the source.

30. The computer-implemented method of claim 27 wherein providing branding is performed dynamically using a dynamic direct feed of branding information from the source.

31. The computer-implemented method of claim 13 wherein the formatting of the parsed information includes stripping contact information from the display listing.

32. The computer-implemented method of claim 13 further comprising providing a data repository where one or more sources of the plurality of online sources can deposit data that is formatted in a pre-determined format, wherein the deposited data is then parsed and repackaged for sending to the user.

33. The computer-implemented method of claim 13 wherein parsing the time-sensitive information includes determining a geographical location of the user who is making a request for time-sensitive information, wherein the geographical location is used for selecting display listings for sending to the user making the request.

34. The computer-implemented method of claim 13 further comprising receiving revenue from one or more entities selected from a group comprising:
the plurality of online sources of time-sensitive information;
customers who pay the plurality of online sources to publish the time-sensitive information; and
the users who request the time-sensitive information.

35. The computer-implemented method of claim 34 wherein receiving revenue is based on at least one payment method selected from a group comprising:
pay-per-click;
cost per thousand impressions; and
fixed fee.

36. The computer-implemented method of claim 13 further including receiving digital text corresponding to the time-sensitive information and wherein formatting includes inserting one or more meta-tags in the digital text.

37. The method of claim 36 wherein formatting further includes selecting one or more keywords for the digital text.

38. The method of claim 37 wherein the selected one or more keywords are inserted in the formatted digital text.

39. The method of claim 37 wherein the one or more meta-tags include one or more keywords for the digital text.

40. The method of claim 36 wherein formatting further includes generating a descriptive title for insertion in the digital text.

41. The method of claim 36 further comprising creating one or more supporting data structures for use in the formatted digital text.

42. The method of claim 41 wherein the one or more supporting data structures include one or more elements from a set of elements, the set of elements comprising:
a title element;
a keyword element;
a description element;
a support URL element; and
a monetization URL element.

43. The method of claim 42 wherein:
the title element stores a title associated with the digital text, wherein the title would be meaningful to web-surfers;
the keyword element stores keywords associated with the digital text;
the description element stores a descriptive narrative associated with a content of the digital text, the narrative being such as to capture attention from web-surfers;
the support URL element stores a first indirection to a pop-up window or web page that provides additional information associated with the digital text; and
the monetization URL element stores a second indirection to information associated with billing of the one or more search engines.

44. An aggregator for aggregating at least one eclassified in response to a users online search request, the aggregator comprising:
a format engine for formatting the eclassified into a format of information suitable for presentation to a user by a publisher; and
a push engine for pushing the formatted information to the publisher for presentation to the user.

45. An instantiated computer process comprising:
executable for aggregating eclassifieds from a plurality of online sources in response to a request.

46. The instantiated computer process of claim 45, comprising:
an aggregator receiving a search query from a search engine affiliated with said aggregator;
said aggregator checking an internal database of said aggregator for search results that satisfy said search query;
said aggregator checking partner eclassified sites for search results that satisfy said search query in the event that such results are not found in the internal database of said aggregator;
said aggregator converting or formatting the digital content found by said aggregator in the internal database of said aggregator or at partner sites into a push format that is suitable for pushing to said search engine;
said aggregator pushing the formatted search results to said search engine;
said aggregator monetizing the successfully completed transaction, attending to any necessary accounting associated with the format and push processes of said aggregator; and
said aggregator performing any necessary housekeeping functions, such as placing usage statistics in a database of said aggregator or transmitting transaction information to search engine affiliates and partners of said aggregator.

47. The method by which the format engine of an aggregator performs the conversion or formatting of eclassified data as recited in claim 46, comprising:
pulling a data file of eclassifieds and receiving said data file in a format specified by said aggregator;
said aggregator determining the format of said eclassified data file;
said aggregator retrieving pertinent data from each eclassified in said data file, such pertinent data including information pertaining to pricing, products and services, source or origin of eclassified data, and contact data; and
said aggregator placing said retrieved pertinent data into a specified push format together with any supporting data structures.

48. The push format data structure of claim 47, comprising:
a title element, a keyword element, a description element, a support URL element, and a monetization URL element.

49. The method of claim 47 for retrieving pertinent data from the eclassified data file of claim 47, comprising:
an aggregator retrieving a data record for a single eclassified found in said eclassified data file;
said aggregator expanding all keywords found in said data record;
said aggregator removing any unnecessary stop words such as ‘a’, ‘the’, and ‘if’;
said aggregator performing lexical expansion of words in said data record; and
said aggregator retrieving pricing information from said data file.

50. The method of claim 47 for formatting data retrieved from the data file of claim 47, into push format, comprising:
an aggregator preparing a text title from said retrieved eclassified data;
said aggregator preparing a text description of said retrieved data;
said aggregator creating a supporting push format data structure for use with an eclassified data record made from said retrieved and formatted data;
said aggregator generating a data record or push data structure having a title, a description, and a URL pointing to said supporting data structure, and
said aggregator encoding said eclassified in a markup language in a specialized format.

51. A computer-implemented method for monetizing a request for search results from a user, the method comprising:
providing a user with an online search interface, said online search interface enabling said user to make search requests;
receiving a specific search request via said online search interface, said specific search request received from said user; and
retrieving eclassifieds from a plurality of online sources, and aggregating said eclassifieds.

52. A computer-implemented method comprising:
aggregating eclassifieds from a plurality of online sources that relate to a portion of online content.

53. The method of claim 52 further comprising providing the aggregated eclassifieds with the portion of online content.

54. The method of claim 53 wherein the portion of online content may be part of a website, pop-up or pop-under.
